(19) United States
(12) Patent Application Publication
(10) Pub. No.: US 2015/0186694 A1
(43) Pub. Date: Jul. 2, 2015

(54) System and Method for Locating Objects and Determining In-Use Status Thereof

(71) Applicant: Lexmark International, Inc., Lexington, KY (US)

(72) Inventors: John Thomas Fessler, Lexington, KY (US); Keith Bryan Hardin, Lexington, KY (US); Julie Ann Gordon Whitney, Georgetown, KY (US)

(73) Assignee: Lexmark International, Inc., Lexington, KY (US)

(21) Appl. No.: 14/145,433

(22) Filed: Dec. 31, 2013

(51) Int. Cl. G06K 7/10

(52) U.S. Cl. CPC G06K 7/10366

(57) ABSTRACT

A RFID based system, including an RFID tag to communicate with a reader and having a motion-based generator generating current upon the device being moved. When the object moves, the RFID tag is configured to transmit at least one signal to the reader using the current generated by the motion-based generator to indicate that the object is in use. The RFID tag may include an energy scavenging circuit such that the RFID tag is also capable of being interrogated by the reader and perform additional operations, independent of the motion-based generator.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Disclosure

The present disclosure relates generally to localization systems, more particularly, to radio frequency identification (RFID) localization methods and systems.

2. Description of the Related Art

In recent years, localization systems have been used in many applications to identify and track different physical entities such as merchandise, equipment, devices, personnel or individuals, and other items or assets that need to be monitored within a particular environment. Example applications include supply chain management applications where localization systems are used for automatic inventory and tracking, and security applications where such services are used to identify and monitor personnel to control access to particular areas within a facility.

Radio frequency identification (RFID) systems have been widely employed for localization due to relatively low implementation cost. An RFID system typically attaches an RFID tag to an object to be monitored. Readers are then deployed in the environment to interrogate the tag as the tagged object passes within range of the readers. In particular, the readers transmit radio frequency (RF) signals to the tag which in turn responds by transmitting an RF response signal containing information identifying the object to which the tag is attached. The response signals received by each reader are then transformed into distance measurements which are utilized to determine an estimated location of the tagged.

Traditional RFID localization systems typically use stationary readers, beacons or access points to receive wireless signals from badges or tags attached to objects in order to produce ranging information and determine the locations of the objects, and are also often installed independent of other existing systems within a facility. As a result, such systems are generally difficult to implement at low cost due to expensive readers and relatively high cost of additional installation.

Accordingly, there is a need for an RFID localization system that can be implemented at lower costs.

### SUMMARY

Embodiments of the present disclosure provide device attachable to an object, including a radio frequency identification (RFID) tag operative to communicate with a reader. The RFID tag includes at least one antenna for communicating signals with the reader, and a motion-based generator generating current upon the device being moved. When the object moves, the motion-based generator powers the RFID tag and the RFID tag is configured to transmit at least one signal to the reader using the current generated by the motion-based generator to indicate that the object is in use. In an example embodiment, the RFID tag transmits the at least one signal at predetermined time intervals during a time period in which the object moves. The at least one signal transmitted may be encoded with in-use status information. The RFID tag further includes an energy scavenging circuit for converting electromagnetic energy from signals received by the at least one antenna into electric current, such that when the object is not moving, the RFID tag operates as a passive tag by using the electric current generated by the energy scavenging circuit upon the RFID tag being interrogated by the reader. In this way, the RFID tag is capable of communicating with the reader when the object to which the RFID tag is attached is in use and also when the RFID tag is interrogated by the reader.

An example embodiment is directed to a method for determining whether the object is in use, including receiving, by the RFID reader, at least one signal from the RFID tag, determining whether the at least one signal is generated using the current from the motion-based generator, and determining that the object is in use based upon the at least one signal being determined to be generated using the current from the motion-based generator.

In one example embodiment, determining whether the at least one signal is generated using the current from the motion-based generator includes determining whether the at least one signal comprises a periodic signal. In another example embodiment, determining whether the at least one signal is generated using the current from the motion-based generator includes determining whether the at least one signal has been transmitted within a predetermined time period. In yet another example embodiment, determining whether the at least one signal is generated using the current from the motion-based generator includes determining whether the at least one signal is encoded with in-use status information.

### BRIEF DESCRIPTION OF THE DRAWINGS

The above-mentioned and other features and advantages of the disclosed example embodiments, and the manner of attaining them, will become more apparent and will be better understood by reference to the following description of the disclosed example embodiments in conjunction with the accompanying drawings, wherein:

FIG. 1 illustrates a network interconnecting a plurality of imaging devices;

FIG. 2 illustrates a floor plan depicting an imaging environment having a plurality of imaging devices;

FIG. 3 is a block diagram of an imaging device according to an example embodiment of the present disclosure;

FIG. 4 is a flowchart illustrating an example method of determining location of an unknown tag using machine learning techniques according to an example embodiment of the present disclosure;

FIG. 5 illustrates a block diagram of modeling engine for defining a prediction function that outputs predicted tag locations according to an example embodiment of the present disclosure;

FIG. 6 is a flowchart illustrating an example method of defining the prediction function according to an example embodiment of the present disclosure;

FIG. 7 is a flowchart illustrating an example method of prediction location of an unknown tag using the prediction function according to an example embodiment of the present disclosure;

FIG. 8 is a flowchart illustrating an example recalibration process for redefining the prediction function according to an example embodiment of the present disclosure;

FIG. 9 is a block diagram of a media input tray having a radio device with two antennas at opposed sides of the media input tray according to an example embodiment of the present disclosure;

FIG. 10 is a block diagram of a tag attached to an object and including a motion-based generator according to an example embodiment of the present disclosure;

FIG. 11 illustrates a network interconnecting a plurality of imaging devices and a plurality of Wi-Fi access points; and

FIG. 12 illustrates a floor plan depicting an imaging environment having a plurality of imaging devices and a plurality of access points.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Spatially relative terms such as “top”, “bottom”, “front”, “back” and “side”, and the like, are used for ease of description to explain the positioning of one element relative to a second element. Terms such as “first”, “second”, and the like, are used to describe various elements, regions, sections, etc. and are not intended to be limiting. Further, the terms “a” and “an” herein do not denote a limitation of quantity, but rather denote the presence of at least one of the referenced item.

Furthermore, and as described in subsequent paragraphs, the specific configurations illustrated in the drawings are intended to exemplify embodiments of the disclosure and that other alternative configurations are possible.

Reference will now be made in detail to the example embodiments, as illustrated in the accompanying drawings. Whenever possible, the same reference numerals will be used throughout the drawings to refer to the same or like parts.

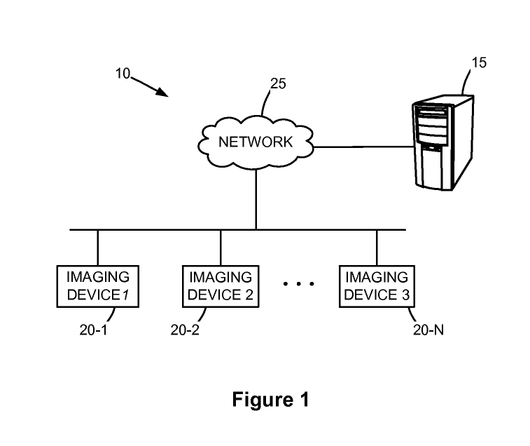

FIG. 1 shows an illustration of a networked system 10 interconnecting a server 15 and a plurality of imaging devices 20 in a computing system environment via a network 25. Network 25 may have any one of a number of network topologies and signal protocols, and may be any type of network, including a local area network (LAN), a wide area network (WAN), a metropolitan area network (MAN), or any other type of network capable of interconnecting network devices. Imaging devices 20 and server 15 may each be connected to network 25 through associated interface devices, such as network interface cards (NICs). Electronic communication between devices may operate using a wired connection, such for example, using Ethernet UTP or fiber optic cables, or a wireless networking standard, such as IEEE 802.XX.

Server 15 may be a web server, a managed print service (MPS) location server, an asset management server, or any remote computing system or device. In an example embodiment, server 15 may be provided to manage interconnected peripheral network devices and assets, such as imaging devices 20, via network 25. Server 15 may include a database which may be used to store information associated with the interconnected assets such as, for example, IP or MAC addresses, status information, operation logs, or location information.

Server 15 may be configured to update the information of its database in response to some events or changes in state related to the assets in the customer location. For example, server 15 may update information associated with a particular imaging device 20 relating to its current location. Information relating to the location of an imaging device may include building name, floor number, room number, station, and other forms of information used to identify an area or location. In order for the location information stored in the database to be accurate, server 15 may constantly monitor changes in locations of the imaging devices 20 and accordingly update location information once changes occur.

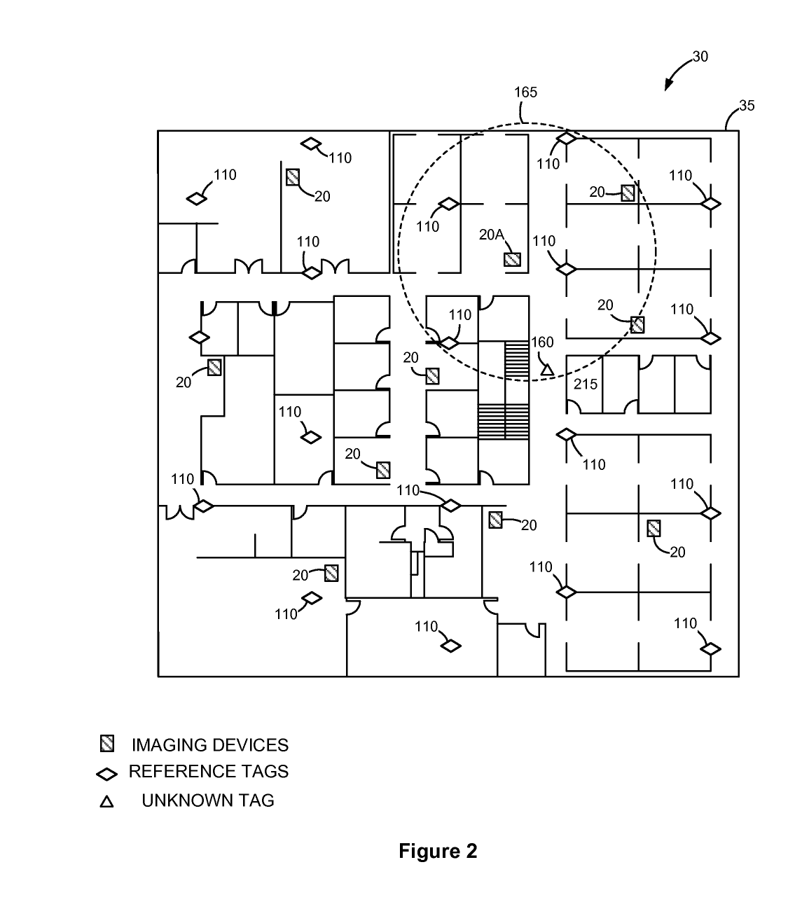

According to an example embodiment, networked system 10 may be configured to provide localization services for identifying, determining, and tracking physical locations of physical entities in a particular environment. More particularly, imaging devices 20 of the networked system 10 may be utilized to provide localization of different assets, equipment, devices, individuals, or other objects within a surrounding space of a location where they are installed. Given that imaging devices 20 are fairly stationary types of devices and do not move very often, they can be used as fixed reference points to detect and locate other objects. In the example shown in FIG. 2, imaging devices 20 are emplaced variously within a physical site, location, or facility represented by a map 30. The map 30 can be any of a variety but is contemplated as a floor plan 35 of a building where the imaging devices 20 are deployed. Typically, imaging devices 20 are positioned at strategic locations to support and optimize accessibility for a number of users.

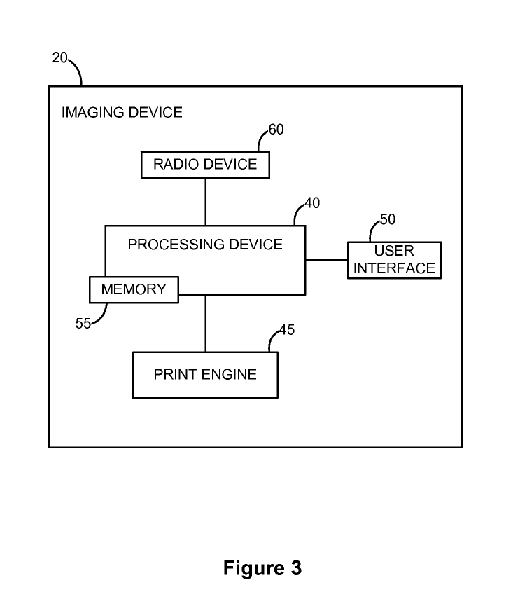

FIG. 3 illustrates a block diagram depicting imaging device 20 including a controller or processing device 40 communicatively coupled to a print engine 45 and a user interface 50. Processing device 40 may include an associated memory 55 and may be formed as one or more Application Specific Integrated Circuits (ASICs). Memory 55 may be any memory device convenient for use with or capable of communicating with processing device 40. Processing device 40 may communicate with print engine 45 and serve to process print data and to operate print engine 45 during printing of an image onto a sheet of media. Print engine 45 may include any of a variety of different types of printing mechanisms including dye-sublimation, dot-matrix, ink-jet or laser printing.

User interface 50 may include a graphical user interface, such as a display panel which may be a touch screen display in which user input may be provided by the user touching or otherwise making contact with graphic user icons in the display panel. In addition, user interface 50 may include any other display mechanism or input mechanism for displaying and receiving information to/from a user.

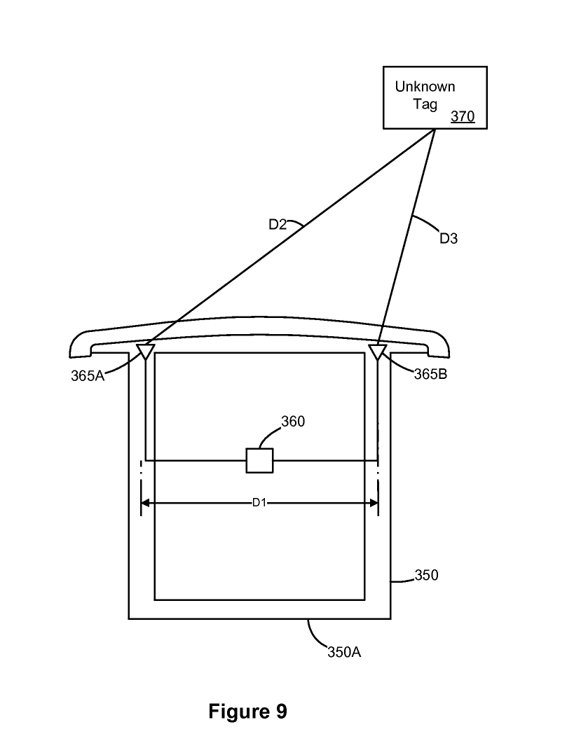

In accordance with example embodiments of the present disclosure, networked system 10 may employ RFID systems on imaging devices 20 to provide localization services. In an example embodiment shown in FIG. 3, each imaging device 20 may be provided with a radio device 60, such as a radio transceiver or transponder, communicatively coupled to processing device 40 to facilitate location determination operations of different objects, as will be explained in greater detail below. In one example, radio device 60 may form part of a media input tray (FIG. 9) of imaging device 20. Alternatively, radio device 60 may be installed elsewhere on imaging device 20. It is understood that a radio device 60 may be installed in other office devices within networked system 10 besides imaging devices 20.

In one example embodiment, each radio device 60 may be derived from a wide variety of RFID readers capable of reading a number of passive, active, and/or semi-passive tags simultaneously within a read/interrogation range. Each radio device 60 may include at least one antenna and a circuit that is configurable to operate as a transmitter and a receiver. In addition, each radio device 60 may also include a backup power source, such as a battery supply, so that radio devices 60 may continue to function in the event associated imaging devices 20 are powered off or lose power due to power interruptions or hardware failure. Objects that need to be monitored may be attached with corresponding tags that can respond to and/or interact with the radio devices 60 on imaging devices 20. Accordingly, each imaging device 20 may utilize its associated single radio device 60 to determine location of a tag attached to an object.

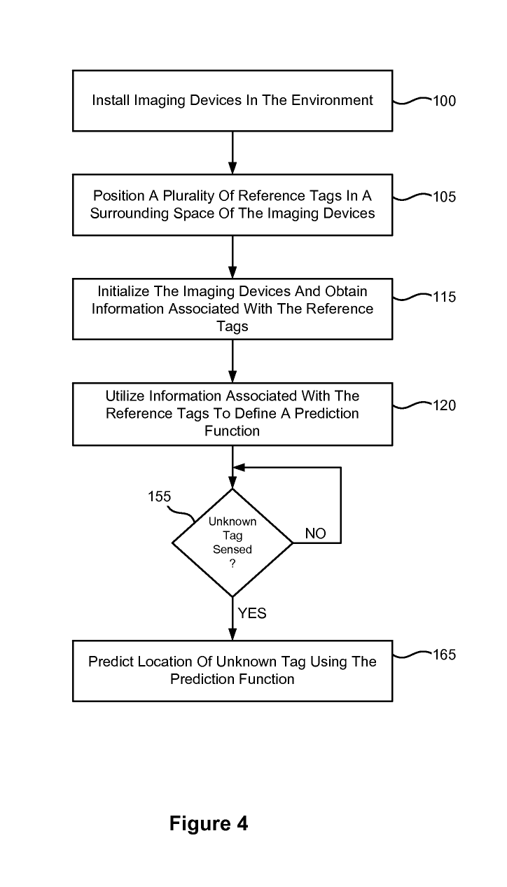

In one example embodiment, imaging devices 20 may utilize one or more machine learning algorithms to determine location of an unknown tag. FIG. 4 shows a flowchart illustrating an example method of determining location of an unknown tag with a single radio device on an imaging device and using machine learning techniques.

At block 100, imaging devices 20 equipped with radio devices 60 are installed at various locations in an environment. The environment, as used herein, is represented by floor plan 35. At block 105, a plurality of reference RFID tags are positioned and installed in the surrounding space of the imaging devices 20. For example, in FIG. 2, floor plan 35 is shown as having reference RFID tags 110 disposed at various locations to surround the imaging devices 20. Each of the reference tags 110 may be fixedly mounted on walls, ceilings, or other fixed points or structures in the environment, and may comprise a passive, active, or semi-passive tag.

At block 115, each imaging device 20 may be initialized. Part of the initialization process by an imaging device 20 may include scanning for reference tags 110 within range using an associated radio device 60, and obtaining location information associated with the detected reference tags. Typically, during scanning, the radio device 60 transmits and receives signals to/from the reference tags 110. Detected reference tags 110 may be identified and displayed on the user interface 50 for viewing by the user.

In one example embodiment, location information associated with the detected reference tags 110 may be obtained by the imaging device 20 by requesting a user to provide corresponding locations of each detected reference tag 110. In one example aspect, the user may be provided with a visual display of the floor plan 35 and requested to note relative locations of the detected reference tags 110 by “pin drops” or other designators such as flags, stars, etc. placed on the floor plan 35. In another example aspect, the user may be requested to manually input location data, such as coordinates, of the detected reference tags 110. Coordinates for individual reference tags may be obtained in various ways. For example, a GPS (Global Positioning System) device may be taken physically nearby a reference tag 110 and used to obtain coordinate values at the current location. Location of the GPS device may then be used to provide an adequate approximation of the location of the reference tag 110. In other examples, location information may be obtained by surveying the site, airborne or satellite mapping, or any other technique that can be employed to determine and obtain location information.

In another example embodiment, location information associated with the detected reference tags 110 may be obtained by the imaging device 20 by retrieving such information directly from the reference tags 110 themselves. In this example, each reference tag 110 may be programmed with their respective locations upon installation. Individual locations of the reference tags 110 may be obtained using methods previously described. Upon initialization of the imaging device 20, radio device 60 may interrogate each reference tag 110 within range to obtain location information therefrom.

Further, during initialization, signals received from the reference tags 110 may be used to determine information/features associated with the reference tags 110. These features may include, but are not limited to, signal strengths and phase shifts with frequency of the signals received from the reference tags 110. Eventually, after initialization, imaging device 20 has a record of data pertaining to signal strengths, phase shifts, and location information of each reference tag 110 within range. Additionally or in the alternative, such may be stored in a storage location associated with server 15.

At block 120, information associated with the reference tags 110 are utilized to train or define a prediction engine or function to output predicted tag locations using machine learning techniques, such as supervised learning techniques, in which a set of training examples comprised of the information associated with the reference tags 110 is presented to a modeling engine to define the prediction function. Generally, each example includes a pair consisting of an input variable/feature corresponding to the one or more features (e.g., a signal strength and phase shift of a signal) associated with a reference tag 110, and an output value/target corresponding to the location information associated with the same reference tag 110. The supervised learning techniques may analyze the training examples and define the prediction function to be used in identifying location of unknown tags. The supervised learning techniques may utilize one or more “minimization of error” algorithms to define a prediction function that minimizes the error between output of the prediction function and the known output values.

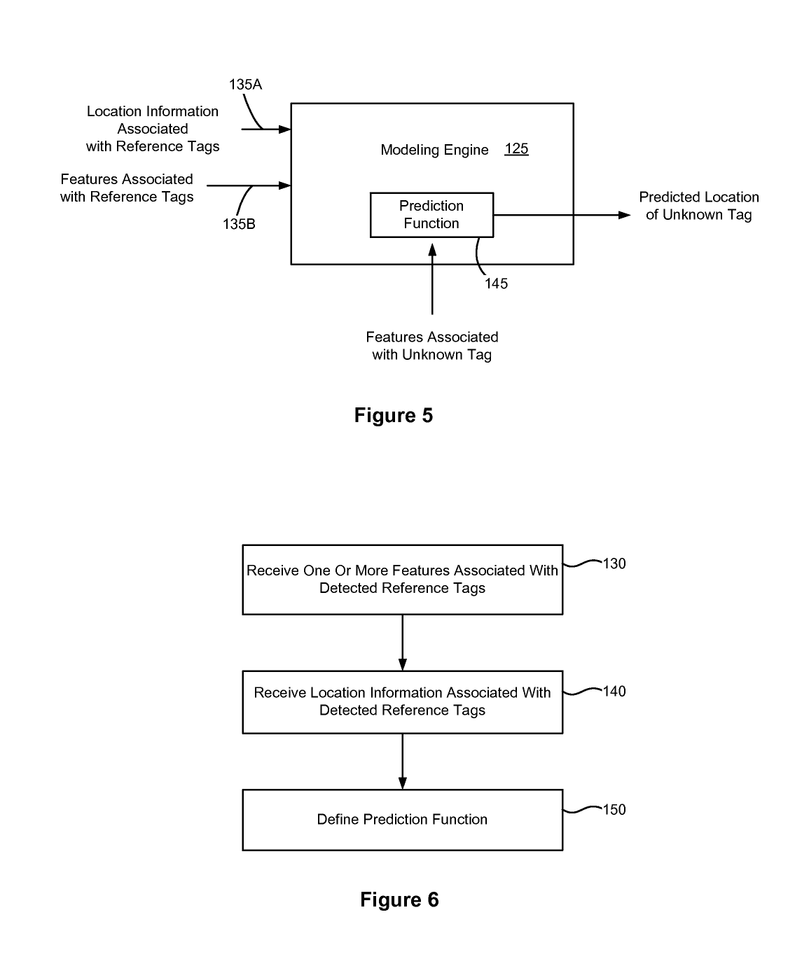

FIG. 5 illustrates a block diagram including a modeling engine 125 that employs one or more machine learning algorithms to define the prediction function while FIG. 6 illustrates an example process in accordance with the block diagram in FIG. 5. Each imaging device 20 may be associated with modeling engine 125. At block 130, modeling engine 125 may receive the one or more of the features associated with the detected reference tags 110 as input features at input 135A, and at block 140, receive the location information associated with the detected reference tags 110 as output targets at input 135B. Using the location information and the one or more features, modeling engine 125 may define a prediction function 145 at block 150 for use in predicting locations of unknown tags attached to monitored objects. In one example embodiment, a modeling engine 125 may be integrated with each imaging device 20. In another example embodiment, modeling engine 125 may be implemented in server 15 or an asset management system. In yet another example embodiment, the modeling engine 125 may be implemented in server 15 while the prediction function 145 may be provided in the imaging device 20.

Referring back to FIG. 4, imaging device 20 may engage in a tag-sensing condition at block 155 after the prediction function 145 has been defined. As an example, consider imaging device 20A in FIG. 2 engaged in the tag-sensing condition. If an unknown tag 160 is detected within range 165 of imaging device 20A, the prediction function 145 associated with imaging device 20A may be utilized to predict the location of the unknown tag 160 at block 165.

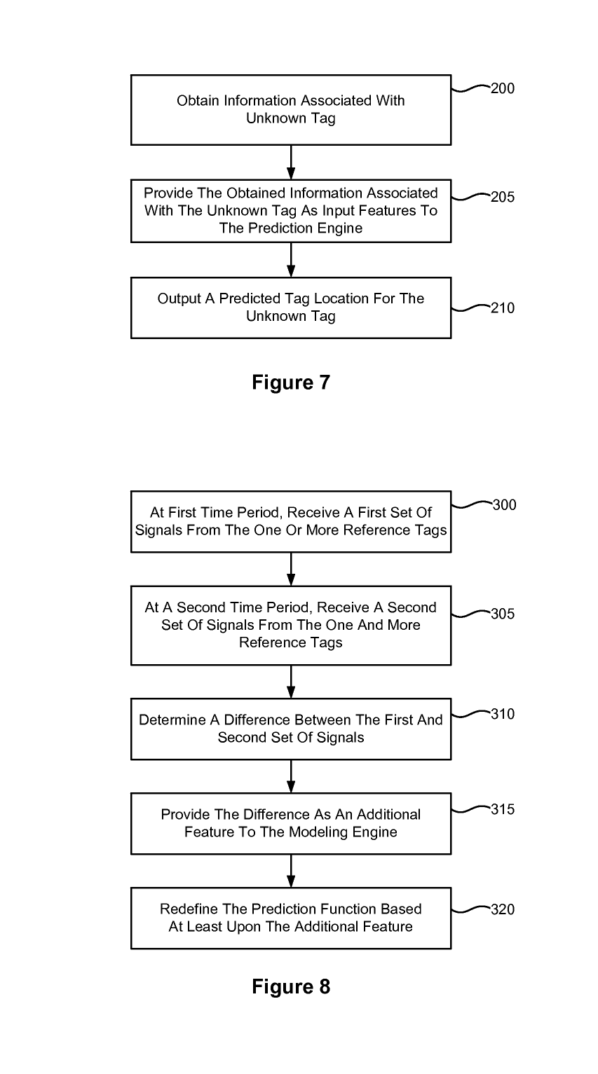

With reference to FIG. 7, a flowchart illustrating an example process of predicting location of unknown tag 160 is shown. At block 200, imaging device 20A may obtain information associated with the unknown tag 160. Such information may correspond to the same type of information associated with reference tags 110, i.e., signal strength and/or phase shift of a signal received from unknown tag 160. At block 205, the obtained information associated with the unknown tag 160 is provided as input features to the prediction function 145. In turn, associated prediction function 145 may output a predicted tag location for the unknown tag at block 210. Predicted location of the unknown tag 160 may be of the same type of information as the location information provided for each of the reference tags 110.

Location of the unknown tag 160 may be provided to the user in different forms. For example, the predicted location of the unknown tag 160 may be communicated to a mapping function which calibrates and superimposes the predicted location on floor plan 35. In one example embodiment, the floor plan 35 marked with the unknown tag 160 location, as shown for example in FIG. 2, may be displayed on a display screen or printed on a print medium. Additionally or in the alternative, descriptive information regarding the unknown tag location may be provided. In this example, different areas or locations on floor plan 35 may be associated with reference terms such as door number, cubicle number, station, floor number, and other terms or forms of information that may be associated with the different parts of floor plan 35. For example, in FIG. 2, cubicle area 215 may be a referenced location on floor plan 35. Given the position of unknown tag 160, cubicle area 215 may be determined as a reference location closest to unknown tag 160. Accordingly, descriptive information which identifies unknown tag 160 as being close or near cubicle area 215 may be provided. Further, additional information may include a calculated distance of the unknown tag 160 from imaging device 20A which detected it. As such, an example descriptive information of the unknown tag location may include a report such as “5 meters from imaging device 20A near cubicle area 215.” As will be appreciated, different ways of providing descriptive information using known reference locations/areas of floor plan 35 may be used. In other example embodiments, the predicted location may be provided to the user in the form of coordinates, either by display or in printed form. As can be appreciated, certain applications may be implemented to allow users to retrieve and/or view the unknown tag locations via workstations, laptops, mobile devices, or any other device that are capable of displaying information.

Generally, changes in the environment may occur after initialization of the imaging devices 20 and even at later times. For example, new objects may be added in the environment that may modify, block, or reflect RFID signals and thus cause variation in signal strengths and phase shifts with frequency of the signals. To account for changes in the environment, recalibration of the prediction function 145 may be performed. FIG. 8 shows a flowchart illustrating an example recalibration process.

At block 300, imaging device 20 may receive a first set of signals from one or more of the reference tags 110 at a first time period. For a first instance of recalibration, this first time period may correspond to the time at which imaging device 20 initialized. Information obtained from the first set of signals may be used to train the prediction function 145. At block 305, imaging device 20 may receive a second set of signals from the same reference tags 110 at a second time period after the first time period. At block 310, a difference between the first and second set of signals may be determined. For example, for a given reference tag 110, the difference between a first set of information (including signal strength and/or phase shift) obtained at the first time period, and a second set of information (including signal strength and/or phase shift) obtained at the second time period may be determined. Block 310 may be performed for each reference tag 110. At block 315, the determined differences may be provided to modeling engine 125 as additional input features for corresponding reference tags 110. In turn, modeling engine 125 may redefine the prediction function 145 based at least upon the additional features at block 320. Accordingly, the prediction function 145 is recalibrated or redefined to account for changes in the environment. The process may be performed in an iterative fashion at predetermined time intervals to account for changes in the environment over time.

In alternative example embodiments, recalibration may be performed by feeding information associated with the unknown tag 160 into modeling engine 125. For example, the user may visually inspect the actual location of the unknown tag 160 and determine whether such properly corresponds to the predicted location as applied to the floor plan 35. If not, the user may indicate a more accurate or proper location of the unknown tag 160 on the floor plan 35, such as by applying a hand gesture on a surface of the display displaying floor plan 35, or by manual input of coordinates. The input features associated with the unknown tag 160 and new location information associated therewith may then be provided as additional input to modeling engine 125 at inputs 135A and 135B for redefining the prediction function 145.

In another example embodiment, imaging devices 20 may utilize other techniques to determine location of an unknown tag, in lieu of or in addition to methods using machine learning techniques described above. For example, radio devices 60 on each imaging device 20 may utilize two antennas spaced apart from each other at a known distance. As shown for example in FIG. 9, a media input tray 350 of imaging device 20 includes a radio device 360 having two antennas 365A and 365B positioned at opposed sides of media input tray 350. In operation, using radio device 360, imaging device 20 may send a query at two different frequencies, such as frequencies that are relatively close but not identical, from each antenna 365 and, upon receiving signals from a responding unknown tag 370, measures the phase shifts on the response signal relative to each of the frequencies for the two antennas 365. Based on the measured phase shifts, distance and/or angle measurements for each antenna 365 may be generated. Knowing a distance D1 between the two antennas 365 and distances D2, D3 of the unknown tag 370 from each of the two antennas 365 may allow calculation of the location of the unknown tag relative to the imaging device 20. However, given just distances D1, D2, and D3, imaging device 20 can assume two symmetrically opposed positions with respect to both of the antennas 365, i.e., either in front or at the back of media input tray 350 (respectively above or below an imaginary reference line connecting the two antennas 365). In order to resolve symmetrical ambiguity with respect to the position of unknown tag 160 relative to media input tray 350 and imaging device 20, a back portion 350A of media input tray 350 may be shielded so that the only possible location of a detected tag is in front of media input tray 350 of imaging device 20. Thus, tag location may be determined using a single reader/radio device on an imaging device.

The localization system and methods described above may be utilized in any of a number of environments and settings in which the location of one or more tags is needed. For example, the system and method may be employed in medical and/or hospital settings for locating people or objects associated with tags and making determinations based upon the tags that are located. In an example embodiment, the above described system and method may be used in a hospital in which tags are associated with each patient receiving medical services in the hospital. A tag may be associated with a patient by affixing the tag to the patient's clothes or having the tag affixed to or embedded within the identification bracelet commonly worn by hospital patients. With each hospital patient being associated with a tag, patients may be more easily and effectively located using the systems and methods described herein. More effective locating of patients helps to ensure patient medications may be more timely administered, helps to ensure patient safety and allows for more accurate patient billing for hospital services. With respect to the latter, a patient's location may be regularly monitored during the patient's hospital stay, and knowing, for example, that a patient spent three days in the intensive care unit of a hospital, through use of the systems and methods described herein, can be used to confirm that the patient's hospital bill is correct.

According to an example embodiment of the present disclosure, information relating to a status/condition of an object with which an unknown tag is attached may be additionally provided to imaging devices 20. In particular, an indication whether the object is in motion and/or in use may be determined based on signals received from the tag attached to the monitored object.

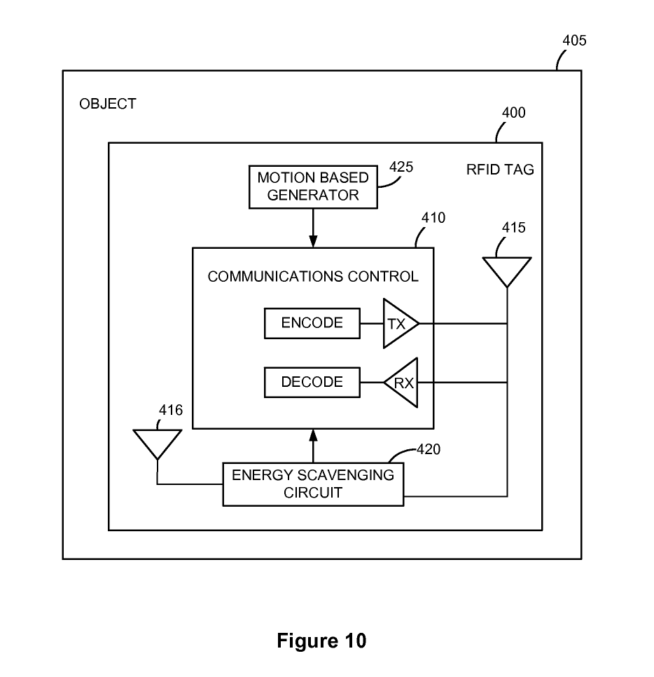

With reference to FIG. 10, there is shown an example RFID tag 400 which is attachable to an object 405 and includes a communications control unit 410, antennae 415 and 416, and an energy scavenging circuit 420. Antenna 415 may be tuned to a frequency at which interrogating radio device 60 communicates, and antenna 416 may be tuned to a frequency of another electromagnetic source in the environment. Energy scavenging circuit 420, which is coupled to antennae 415 and 416, serves to convert electromagnetic energy of radio signals received by antennae 415 and 416 into electrical power used by communications control circuit 410.

In an example embodiment, energy scavenging circuit 420 includes a bulk capacitor for holding a charge corresponding to energy scavenged from a received signal, and a voltage regulator coupled to the bulk capacitor (not shown). Whereas a set of bridge diodes may be coupled to the bulk capacitor for placing energy thereon when receiving energy from a single source, in order to scavenge energy from signals received from multiple sources, in this case antennae 415 and 416, a separate set of bridge diodes (also not shown) is coupled between each antenna and the bulk capacitor for storing energy therein. In this way, antennae 415 and 416 are suitably electrically isolated from each other.

When powered, communications control unit 410 may decode and/or demodulate received information signals and encode, modulate, and transmit information signals to interrogating radio device 60 using antenna 415. In addition, communications control unit 410 may perform additional functions. Use of multiple antennae 415 and 416 allows, for example, for communications control unit 410 of RFID tag 400 to receive sufficient power from an interrogation signal by radio device 60 via antenna 415 to function as a conventional passive RFID tag in responding to the interrogation signal, and to perform one or more additional functions not performed by a conventional passive RFID tag by scavenging additional energy via antenna 416. Energy scavenging circuit 420 may also be used to increase the range of RFID tag 400.

Further, RFID tag 400 may include a motion-based generator 425. Generally, motion-based generator 425 may comprise a device which generates relatively small amounts of electric current when moved. For example, motion-based generator 425 may be one which can extract mechanical energy from motion or vibration of object 405 to which it is attached, and scavenge electrical energy by efficiently converting the mechanical energy into electrical power. Example implementations of motion-based generator 425 include a piezoelectric transducer or an intertial magnet within a coil or loop. Accordingly, if object 405 attached with RFID tag 400 moves, RFID tag 400 may be excited by the current generated by motion-based generator 425 and cause to transmit at least one signal even without being interrogated by a radio device 60. The at least one signal transmitted by the RFID tag 400 may be used to indicate an “in-use” and/or an “in-motion” status of the object 405.

In an example embodiment, in-use status of object 405 may be determined by determining whether signals received from RFID tag 400 is generated using current from motion-based generator 425. In one example, RFID tag 400 may transmit signals at predetermined time intervals using current generated by motion-based generator 425 when object 405 moves. In response, one or more of the radio devices 60 on the imaging devices 20 may receive a plurality of periodic signals from RFID tag 400 at spaced intervals and, based thereon, may determine that the object 405 associated with RFID tag 400 is in use. In another example, signals transmitted by RFID tag 400 may be encoded with additional information indicative of an in-use and/or in-motion status if power is received from the motion-based generator 425. For example, an in-use and/or in-motion status information may be stored in memory (not shown) and retrieved therefrom upon encoding a signal for transmission when RFID tag 400 is excited by current generated by motion-based generator 425. In turn, radio devices 60 that receive the transmitted signal may decode information contained therein and determine whether object 405 associated with RFID tag 400 is in use and/or in motion.

In another example embodiment, in-use status of object 405 may be determined in conjunction with its relative location. In particular, location of RFID tag 400 attached to object 405 may be determined using methods previously described at predetermined time intervals. If the location of RFID tag 400 does not change (or remains substantially the same within a time period) and signals are being transmitted by RFID tag 400 within the time period, then it may be determined that object 405 is relatively stationary, but is in use.

Accordingly, RFID tag 400 may operate as a passive tag when responding to interrogations by a radio device 60, and as an active tag when transmitting at least one signal using current from motion-based generator 425 when object 405 moves, such as due to mechanical vibrations and/or transportation to another location. The capability of identifying whether an item, asset, or object is in use in addition to identifying location may provide an efficient way for managing usage of assets and equipment.

In a medical and/or hospital setting, RFID tag 400 may allow for the capability of identifying whether medical or hospital equipment is in use. For example, medical or hospital equipment oftentimes includes a motor having a rotor which moves when the motor is running, or otherwise includes a component that moves when the equipment is in use. When RFID tag 400 is attached to such equipment, equipment motion may be detected by motion-based generator 425 and used to provide power to communications control unit 410 for causing at least one RF signal to be transmitted thereby. Radio device 60 and/or processing device 40 may determine that the medical/hospital equipment is in use based upon the RF signal(s) received, as explained above, and thereafter search for other medical/hospital equipment that is unused.

According to another example embodiment of the present disclosure, information pertaining to angular orientation of RFID tag 400 may be obtained from signals received from RFID tag 400 in order to determine the orientation of object 405. In particular, tag orientation may change the strength of a response signal transmitted by RFID tag 400 to a radio device depending on how well the electromagnetic wave of the response signal lines up with the antenna of the radio device. Accordingly, based on variations in the measured signal strength of the response signal, orientation of RFID tag 400 and consequently object 405 may be additionally estimated.

According to another example embodiment of the present disclosure, the localization capabilities of the imaging devices 20, as discussed above, may be used to augment other location-based services. For example, imaging devices capable of performing RFID localization may be deployed in an environment that utilizes Wi-Fi networks to perform location tracking of tags on clients, asset, devices, and other objects. Typically, to properly track tags in a Wi-Fi location-based service, at least three access points are needed to detect and report the received signal strength (RSSI) of a tag being tracked. In order to obtain accurate localization, Wi-Fi hotspots need to be dense enough. However, Wi-Fi hotspots employed in various organizations are mostly not densely populated to avoid overlapping channels which can often hinder performance. Additionally, introducing more access points may entail high installation costs. As such, Wi-Fi hotspots may not be dense enough to do accurate localization. Thus, by augmenting Wi-Fi location-based services, localization accuracy may be improved.

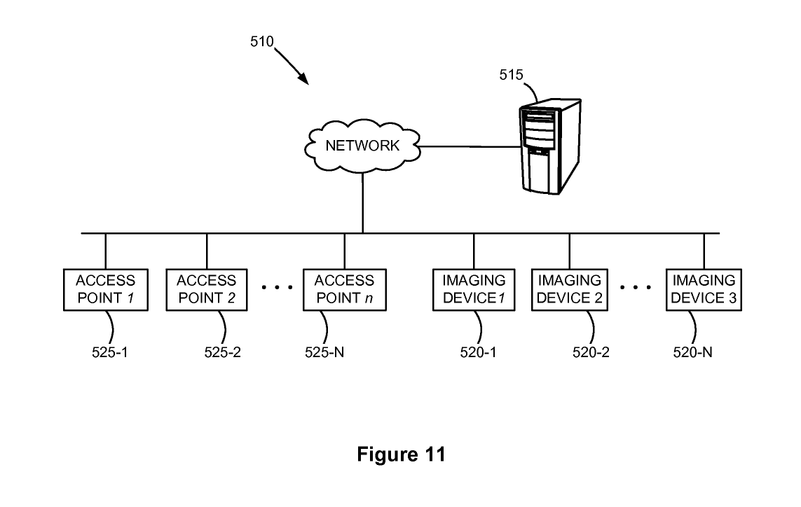

With reference to FIG. 11, there is shown a networked system 510 interconnecting a server 515, a plurality of imaging devices 520, and a plurality of Wi-Fi access points 525 in a computing system environment. Imaging devices 520 may be equipped with readers/radio devices for RFID localization, as previously described, and access points 525 can be capable of performing RFID localization as well.

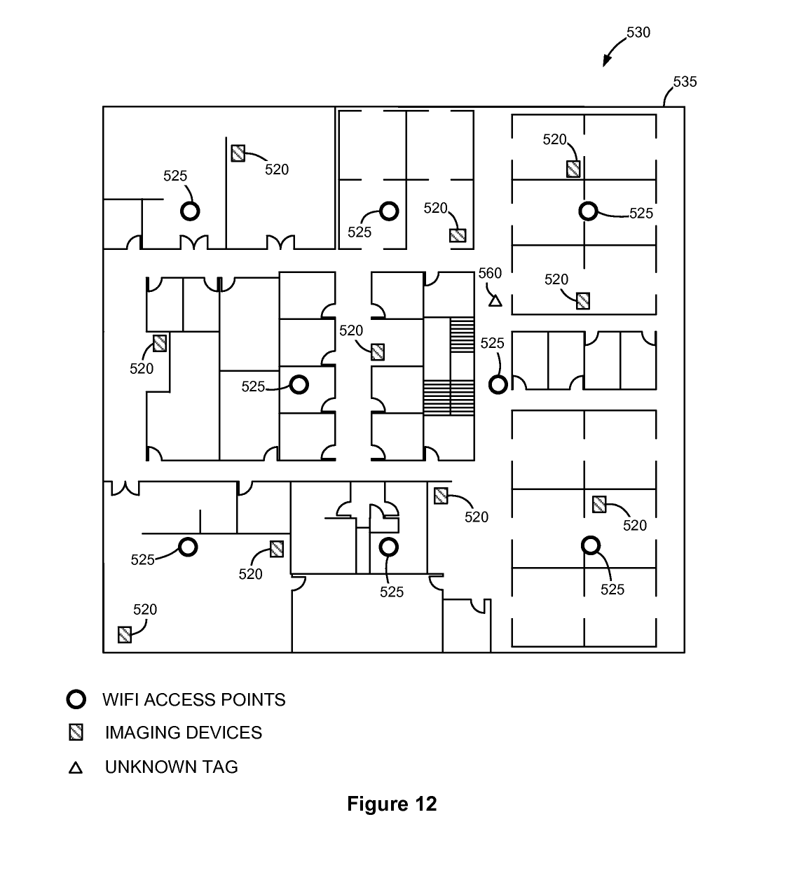

In FIG. 12, imaging devices 520 and access points 525 are positioned at various locations on a map 530 represented by a floor plan 535. In one example embodiment, one or more of access points 525 may detect and localize an unknown tag 560. Additionally, imaging devices 520 may localize unknown tag 560 using techniques described above. By augmenting the localization capabilities of the Wi-Fi network using the localization capabilities of the imaging devices 520, accuracy of determining location of the unknown tag 560 may be improved. In another example embodiment, one or more of access points 525 and one or more of imaging devices 520 may scan and detect unknown tag 560, and produce ranging information that includes, for example, distance calculations/estimations between themselves and the unknown tag 560. Thereafter, each access point 525 and imaging device 520 may forward the ranging information containing distance estimations to server 515 for processing. In turn, server 515 may utilize the collected ranging information to determine the location of unknown tag 560 and use a mapping function to display the location of unknown tag 560 on map floor plan 535. Accordingly, using combinations of access points 525 and imaging devices 520 for RFID localization may provide a relatively more accurate tag location.

The description of the details of the example embodiments have been described using imaging devices. However, it will be appreciated that the teachings and concepts provided herein may also be applicable to other relatively stationary computing devices deployed in a particular environment.

The foregoing description of several example embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A device attachable to an object, comprising:
a radio frequency identification (RFID) tag operative to communicate with a reader, the RFID tag including:
at least one first antenna for transmitting signals to and receiving signals from the reader; and
a motion-based generator generating current upon the device being moved, wherein when the object moves, the RFID tag is configured to transmit at least one signal to the reader using the at least one first antenna and the current generated by the motion-based generator to indicate that the object is in use.

2. The device of claim 1, wherein the RFID tag transmits the at least one signal at predetermined time intervals during a time period at which the object moves.

3. The device of claim 1, wherein when the object moves, the at least one signal transmitted is encoded with in-use status information.

4. The device of claim 1, wherein the RFID tag further includes an energy scavenging circuit coupled to the at least one first antenna for converting electromagnetic energy from signals received by the at least one first antenna into electric current, wherein when the object is not moving, the RFID tag uses the electric current generated by the energy scavenging circuit to transmit information to the reader.

5. The device of claim 4, wherein the RFID tag further includes at least one second antenna coupled to the energy scavenging circuit, the at least one second antenna being tuned to at least one frequency other than a frequency to which the at least one first antenna is tuned, the energy scavenging circuit converting electromagnetic energy from signals received by the at least one second antenna into electric current for powering the RFID tag.

6. A method for indicating whether an object is in use, comprising:
installing a radio frequency identification (RFID) tag on the object;
providing the RFID tag with a motion-based generator which generates current when moved; and
upon the object moving, transmitting, by the RFID tag, at least one signal to an RFID reader using the current generated by the motion-based generator to indicate that the object is in use;
wherein the RFID reader receives the at least one signal and determines that the object is in use based upon the at least one signal.

7. The method of claim 6, wherein the at least one signal comprises a periodic signal.

8. The method of claim 6, wherein the at least one signal is transmitted at predetermined time intervals during a time period at which the object remains moving.

9. The method of claim 6, wherein the at least one signal is encoded with an in-use status information when the RFID tag is excited by the current generated by the motion-based generator.

10. The method of claim 6, further comprising:
providing the RFID tag with an energy scavenging circuit for generating current from electromagnetic energy of signals received by the RFID tag; and
when the object is not moving and the RFID reader interrogates the RFID tag, transmitting, by the RFID tag, a response signal to the RFID reader using the current generated by the energy scavenging circuit, the response signal indicating that the object is not in use.

11. A method for determining whether an object is in use, the object attached with circuitry including a radio frequency identification (RFID) tag and a motion-based generator having an output coupled to the RFID tag and generating current when moved, comprising:
receiving, by an RFID reader, at least one signal from the RFID tag,
determining whether the at least one signal is generated using the current from the motion-based generator; and
determining that the object is in use based upon the at least one signal being determined to be generated using the current from the motion-based generator.

12. The method of claim 11, wherein the determining whether the at least one signal is generated using the current from the motion-based generator includes determining whether the at least one signal comprises a periodic signal.

13. The method of claim 11, wherein the determining whether the at least one signal is generated using the current from the motion-based generator includes determining if the at least one signal has been transmitted within a predetermined time period.

14. The method of claim 11, wherein the determining whether the at least one signal is generated using the current from the motion-based generator includes determining whether the at least one signal is encoded with an in-use status information.

15. The method of claim 11, further comprising determining a location of the RFID tag, wherein the object is determined to be in use when the location of the RFID tag is not changing within a time period and the at least one signal is received from the RFID tag within the time period.

16. The method of claim 11, further comprising determining an angular orientation of the object based upon the at least one signal received by the RFID reader from the RFID tag.
